(19) United States
(12) Patent Application Publication
(10) Pub. No.: US 2026/0203124 A1
(43) Pub. Date: Jul. 16, 2026

(54) Quantum Multi Objective Resource Allocation

(71) Applicant: Bank of America Corporation, Charlotte, NC (US)

(72) Inventors: Kritika Rai, Maharashtra (IN); Sheetal Bhatia, Maharashtra (IN); Sandeep Chauhan, Hyderabad (IN)

(21) Appl. No.: 19/020,280

(22) Filed: Jan. 14, 2025

(51) Int. Cl. G06F 9/50; G06N 10/60

(52) U.S. Cl. CPC G06F 9/5044; G06F 9/5055; G06N 10/60

(57) ABSTRACT

A computing platform may receive a program execution request for execution across a distributed computing environment. The computing platform may identify a complexity of the program execution request, and may generate corresponding qubit values. The computing platform may input the qubit values into a quantum multi objective optimization engine, configured to output, using quantum superposition and entanglement, and based on the qubit values, candidate solutions, and where each of the candidate solutions may be a potential resource allocation for processing the program execution request. The computing platform may score the candidate solutions based on one or more objectives. The computing platform may select, based on the scoring, a candidate solution. The computing platform may generate, based on the candidate solution, a resource allocation script. The computing platform may execute the resource allocation script to process the program execution request using a resource allocation corresponding to the candidate solution.

### BACKGROUND

In some instances, to efficiently optimize resource allocation in a distributed environment, multiple objectives must be achieved, such as minimizing execution time, reducing communication overhead, optimizing cost efficiency, maximizing throughput, balancing resource utilization, or the like. In some instances, these multiple objectives may be tailored based on specific requirements, constraints, and priorities of the distributed environment and an underlying application. In classical systems, multi objective optimization (MOO) may represent a trade-off between conflicting objectives, which may require manual intervention to choose a resource allocation strategy based on their specific priorities only. However, as the number of objectives increases, complexity and dimensionality of the problem may increase exponentially. As such, a classical algorithm may run longer, which may lead to increased computation and resource requirements, along with inadequate exploration of a search space. Accordingly, the classical solution might not be efficient in satisfying multiple objectives.

### SUMMARY

Aspects of the disclosure provide effective, efficient, scalable, and convenient technical solutions that address and overcome the technical problems associated with program execution and resource allocation. In accordance with one or more embodiments of the disclosure, a computing platform comprising at least one processor, a communication interface, and memory storing computer-readable instructions may receive a program execution request for execution across a distributed computing environment. The computing platform may identify a complexity of the program execution request. The computing platform may generate one or more qubit values representing the complexity. The computing platform may input the one or more qubit values into a quantum multi objective optimization engine, which may be configured to output, using quantum superposition and quantum entanglement, and based on the one or more qubit values, a plurality of candidate solutions, and each of the plurality of candidate solutions may be a potential resource allocation for processing the program execution request. The computing platform may score the plurality of candidate solutions based on one or more objectives. The computing platform may select, based on the scoring, a first candidate solution. The computing platform may generate, based on the first candidate solution, a resource allocation script. The computing platform may execute the resource allocation script, which may cause processing of the program execution request using a first resource allocation corresponding to the first candidate solution.

In one or more instances, the computing platform may train, based on historical program execution information, the quantum multi objective optimization engine, where the historical program execution information includes one or more of: computing resources, operation complexity, or program execution requests. In one or more instances, the computing platform may monitor the first resource allocation to collect processing feedback. The computing platform may update, based on the processing feedback, the quantum multi objective optimization engine.

In one or more examples, scoring the plurality of candidate solutions based on one or more objectives comprises applying different weighting to one or more features of the quantum multi objective optimization engine. In one or more examples, the plurality of candidate solutions are simultaneously analyzed based on the quantum superposition and the quantum entanglement.

In one or more instances, the one or more qubit values represent one or more of: a number of computing devices in the distributed computing environment, a memory of the computing devices, or a number of cores per computing device. In one or more instances, scoring the plurality of candidate solutions comprises scoring, based on one or more constraints, the plurality of candidate solutions, wherein each of the one or more constraints are defined by a corresponding objective function.

In one or more examples, a constraint of the one or more constraints may be minimizing execution time, and wherein the corresponding objective function may be: minimize

$$f ( execution ) = {\sum }_{i = 1}^{n} 〚 ExecutionTime ( {Task}_{i} ) * ResourceTime ( {Resource}_{i} 〛 ) .$$

In one or more examples, a constraint of the one or more constraints may be reducing communication overhead, and the corresponding objective function may be: minimize ƒ(communication)=Σ_{i,j} [symbol] CommunicationOverhead(Taskᵢ,Taskⱼ [symbol] )×ResourceAllocation(Taskᵢ,Resourceᵢ)×ResourceAllocation(Taskⱼ, Resourceⱼ).

In one or more instances, a constraint of the one or more constraints comprises maximizing throughput, and wherein the corresponding objective function comprises: maximise ƒ(throughput)=Σᵢ [symbol] Throughput(Resourceᵢ [symbol] )×ResourceAllocation(Taskᵢ, Resourceᵢ). In one or more instances, a constraint of the one or more constraints may be balancing resource utilization, and where the corresponding objective function may be: minimize ƒ(balance)=(Σᵢ [symbol] ResourceUtilization(Resourceᵢ [symbol] )−TargetUtilization)².

### BRIEF DESCRIPTION OF DRAWINGS

The present disclosure is illustrated by way of example and is not limited in the accompanying figures in which like reference numerals indicate similar elements and in which:

FIGS. 1A and 1B depict an illustrative computing environment for using quantum computing for efficient optimization of resource allocation in accordance with one or more example embodiments.

FIGS. 2A-2D depict an illustrative event sequence for using quantum computing for efficient optimization of resource allocation in accordance with one or more example embodiments.

FIG. 3 depicts an illustrative method for using quantum computing for efficient optimization of resource allocation in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. In some instances other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

The following description relates to efficient optimization of resource allocation in distributed environments. For example, to efficiently optimize resource allocation in distributed environments, multiple objectives may need to be met while satisfying constraints of a resource allocation problem, such as geographical location of data/compute, task dependency, resource availability, capacity constraints, or the like. For efficient resource allocation, various objectives may need to be achieved such as minimizing execution time, reducing communication overhead, optimizing cost efficiency, maximizing throughput, balancing resource utilization, or the like.

These multiple objectives may be tailored based on specific requirements, constraints and priorities of a distributed system and/or the underlying application. In classical systems, multi objective optimization (MOO) may represent a trade-off between conflicting objectives, which may need manual intervention to choose a resource allocation strategy based on their specific priorities only. As a number of objectives increases, complexity and dimensionality of the problem may increase exponentially, and hence a classical algorithm may run longer, which may lead to increased computation, resource requirements, and inadequate exploration of search space. As a result, this classical solution might not be efficient with satisfying multiple objectives.

Accordingly, to optimize resource allocation, multiple objectives may be defined. These objectives may include minimizing execution time, reducing communication overhead, and balancing resource utilization. The algorithm may formulate these objectives into a multi-objective optimization problem.

Candidate resource allocations may be represented as quantum states. This representation may allow the algorithm to explore the solution space efficiently by leveraging quantum principles such as superposition and entanglement.

Network traffic generated by parallelized tasks may be considered. For example, communication patterns between tasks may be considered to minimize data transfer overhead to allocate resources strategically, such as in scenarios where compute resources are distributed across different geographical locations.

The algorithm may be designed to be location aware, and may consider the geographical distribution of compute resources. It may factor in the distance and network latency between nodes in different locations, and may optimize resource allocation based on the physical proximity of resources.

This solution may adapt to dynamic changes in the computing environment. For example, it may dynamically adjust resource allocations based on variations in workload, changes in code complexity, fluctuations in availability of resources in different locations, or the like.

The solution may use quantum memory-based computation to adjust resource allocations based on variations in workload, changes in code complexity, and/or fluctuations in the availability of resources in different locations. Each resource allocation scenario (or candidates) may be represented as a state in a quantum system. This representation may allow the algorithm to explore the solution space efficiently by leveraging quantum principles such as superposition and entanglement. Quantum gate operations may be used to manipulate a quantum state of the quantum bits (qubits) to optimize resource allocation parameters based on multiple objectives dynamically.

These and other features are described in greater detail below.

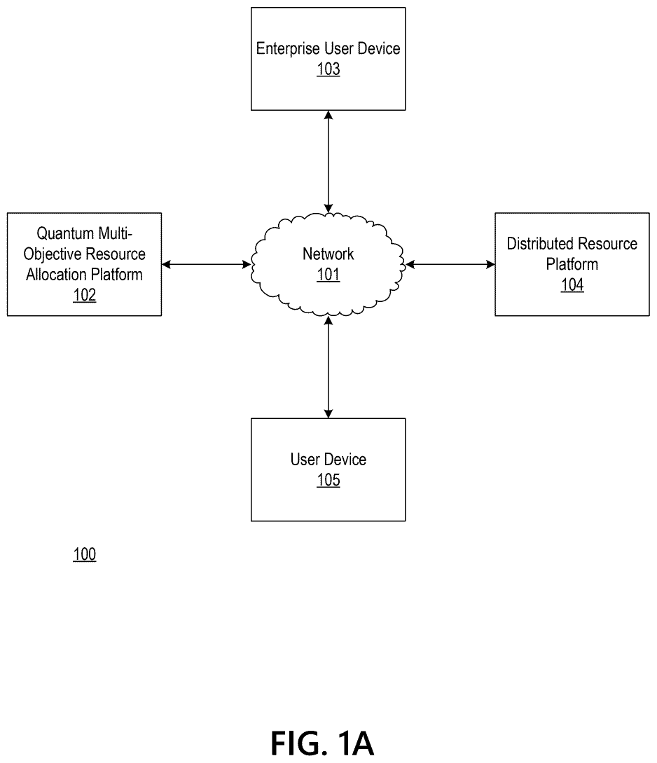

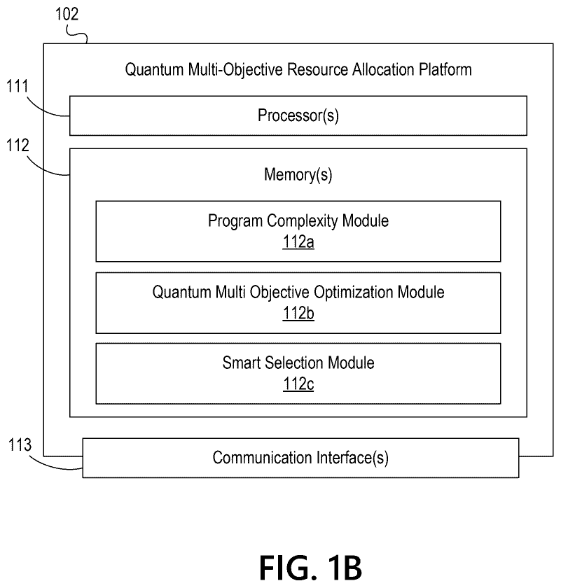

FIGS. 1A-1B depict an illustrative computing environment for using quantum computing for efficient optimization of resource allocation in accordance with one or more example embodiments. Referring to FIG. 1A, computing environment 100 may include one or more computer systems. For example, computing environment 100 may include quantum multi-objective resource allocation platform 102, enterprise user device 103, distributed resource platform 104, and user device 105.

Quantum multi-objective resource allocation platform 102 may include one or more computing devices (servers, server blades, or the like) and/or other computer components (e.g., processors, memories, communication interfaces, or the like). For example, the quantum multi-objective resource allocation platform 102 may be configured to use quantum entanglement and superposition to optimize resource selection for program execution. For example, the quantum multi-objective resource allocation platform 102 may be configured to train, host, and/or otherwise apply an artificial intelligence model to select resources for program execution.

Enterprise user device 103 may be or include one or more devices (e.g., laptop computers, desktop computer, smartphones, tablets, and/or other devices) configured for initiating program execution. For example, the enterprise user device 103 may be operated by an employee of an enterprise organization, and may be configured to display graphical user interfaces.

Distributed resource platform 104 may be or include one or more computing devices (servers, server blades, or the like) and/or other computer components (e.g., processors, memories, communication interfaces, or the like), which may, e.g., be arranged in a distributed manner, and may be configured for program execution. In some instances, the distributed resource platform 104 may include one or more computing systems that may be dependent on the operation of other computing systems, and/or computing systems that may control and/or otherwise manage the operation of other computing systems.

User device 105 may be or include one or more devices (e.g., laptop computers, desktop computer, smartphones, tablets, and/or other devices) configured to display information output by execution of the one or more programs. For example, the user device 105 may display information associated with advertising campaigns and/or other information.

Computing environment 100 also may include one or more networks, which may interconnect quantum multi-objective resource allocation platform 102, enterprise user device 103, distributed resource platform 104, and user device 105. For example, computing environment 100 may include a network 101 (which may interconnect, e.g., quantum multi-objective resource allocation platform 102, enterprise user device 103, distributed resource platform 104, and user device 105).

In one or more arrangements, quantum multi-objective resource allocation platform 102, enterprise user device 103, distributed resource platform 104, and user device 105 may be any type of computing device capable of receiving a user interface, receiving input via the user interface, and communicating the received input to one or more other computing devices, and/or training, hosting, executing, and/or otherwise maintaining one or more artificial intelligence models. For example, quantum multi-objective resource allocation platform 102, enterprise user device 103, distributed resource platform 104, and user device 105, and/or other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of quantum multi-objective resource allocation platform 102, enterprise user device 103, distributed resource platform 104, and user device 105 may, in some instances, be special-purpose computing devices configured to perform specific functions.

Referring to FIG. 1B, quantum multi-objective resource allocation platform 102 may include one or more processors 111, memory 112, and communication interface 113. A data bus may interconnect processor 111, memory 112, and communication interface 113. Communication interface 113 may be a network interface configured to support communication between quantum multi-objective resource allocation platform 102 and one or more networks (e.g., network 101, or the like). Memory 112 may include one or more program modules having instructions that when executed by processor 111 cause quantum multi-objective resource allocation platform 102 to perform one or more functions described herein and/or one or more databases that may store and/or otherwise maintain information which may be used by such program modules and/or processor 111. In some instances, the one or more program modules and/or databases may be stored by and/or maintained in different memory units of quantum multi-objective resource allocation platform 102 and/or by different computing devices that may form and/or otherwise make up quantum multi-objective resource allocation platform 102. For example, memory 112 may have, host, store, and/or include program complexity module 112a, quantum multi objective optimization module 112b, and smart selection module 112c. Program complexity module 112a may store one or more instructions that, when executed by the quantum multi-objective resource allocation platform 102 may identify a complexity of a given program execution request. Quantum multi objective optimization module 112b may store one or more instructions that, when executed by the quantum multi-objective resource allocation platform 102, may identify candidate resource allocation configurations and score the configurations accordingly. In some instances, this quantum multi objective optimization module 112b may include an artificial intelligence engine, which may be trained, maintained, and applied to identify and score these candidate resource allocation configurations. Smart selection module 112c may select a candidate resource allocation configuration from the identified configurations.

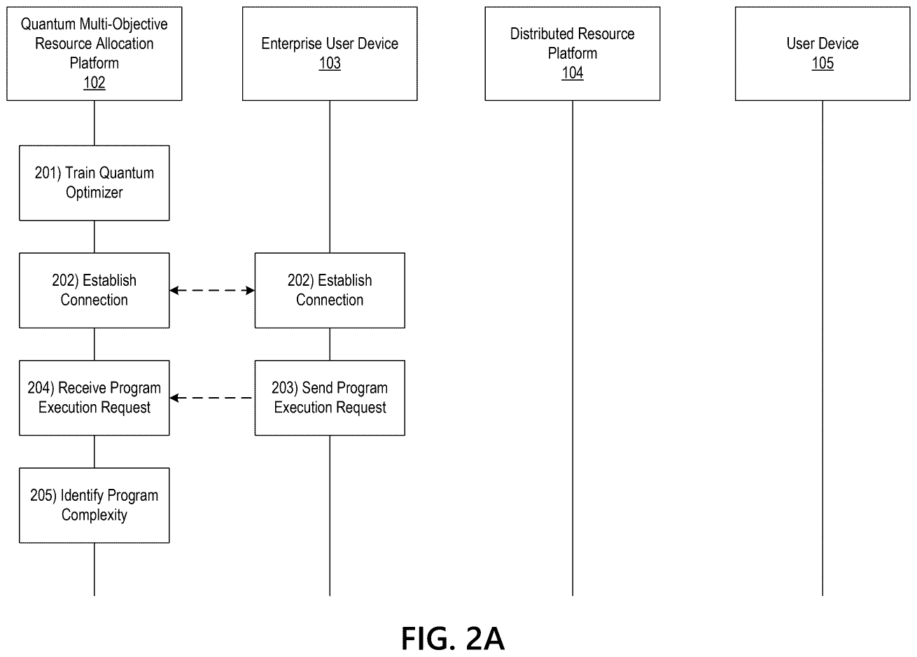

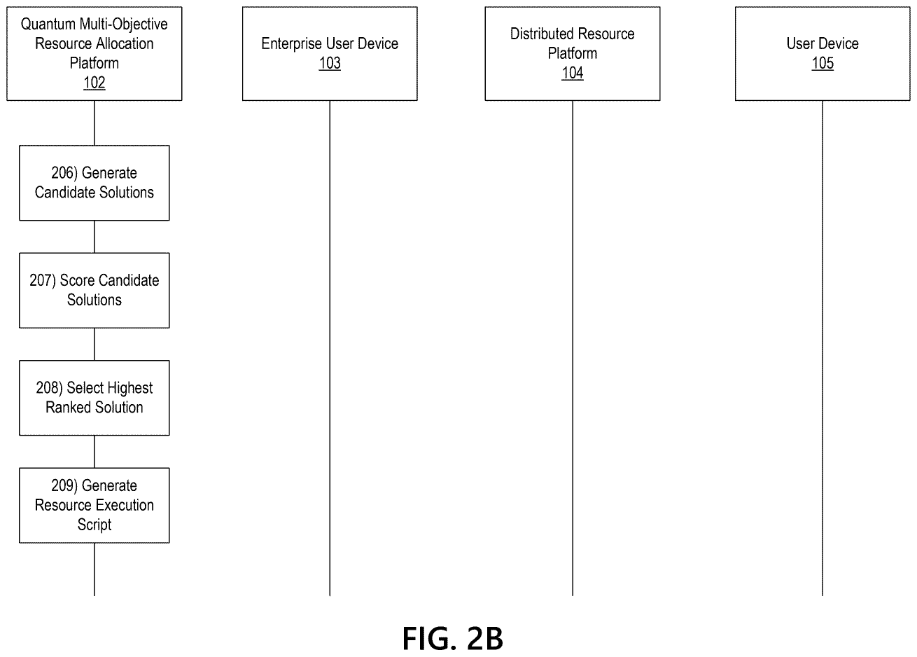

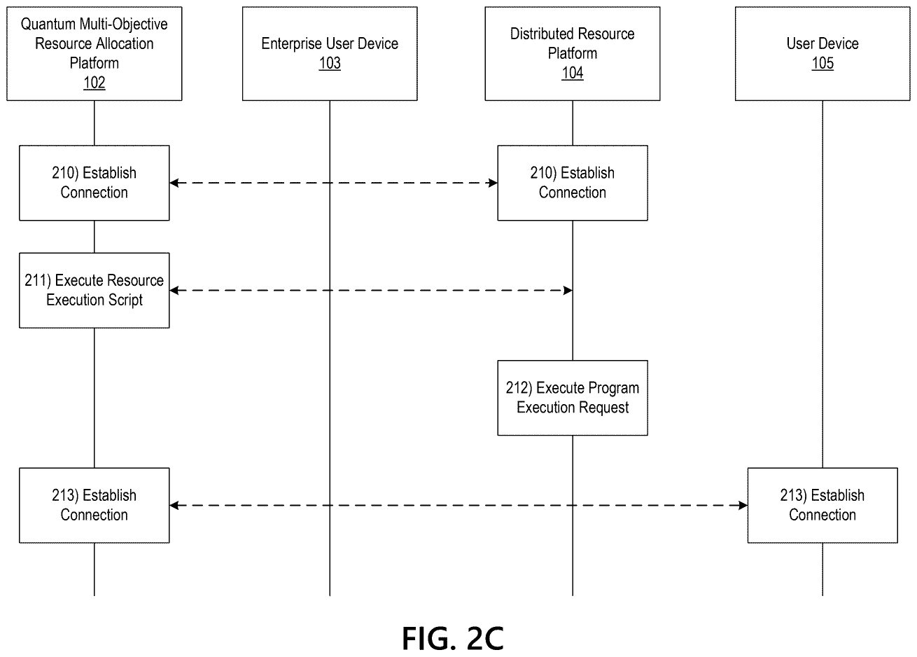

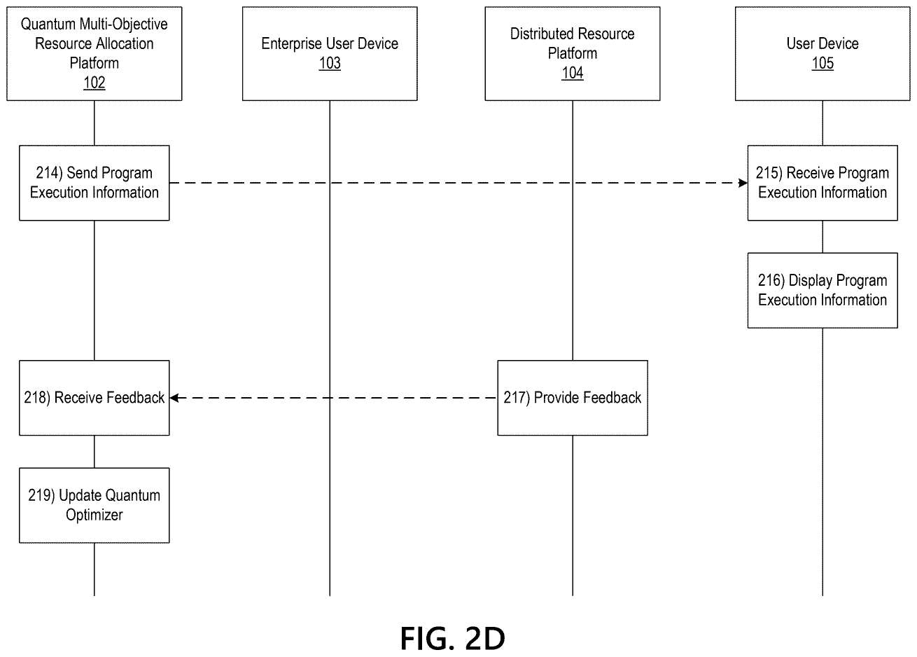

FIGS. 2A-2D depict an illustrative event sequence for using quantum computing for efficient optimization of resource allocation in accordance with one or more example embodiments. Referring to FIG. 2A, at step 201, quantum multi-objective resource allocation platform 102 may train a quantum multi-objective optimization model, which may e.g., be an artificial intelligence engine. For example, the quantum multi-objective resource allocation platform 102 may train the quantum multi-objective optimization model to produce, score, and select candidate resource allocation configurations for a given program execution request. For example, various resource allocations may be scored based on how efficiently they may process the program execution request according to one or more objectives.

In some instances, to perform such training, the quantum multi-objective resource allocation platform 102 may feed a plurality of historically executed programs, along with the corresponding resource allocations and processing conditions, into the quantum multi-objective optimization model. In some instances, these programs may be labelled with a corresponding optimization score indicative of how efficiently the corresponding resource allocation processed the program request. In doing so, the quantum multi-objective resource allocation platform 102 may train the quantum multi-objective optimization model to generate stored correlations between program execution requests, processing conditions, resource allocations, and optimization scores.

At step 202, the quantum multi-objective resource allocation platform 102 may establish a connection with the enterprise user device 103. For example, the quantum multi-objective resource allocation platform 102 may establish a first wireless data connection with the enterprise user device 103 to link the quantum multi-objective resource allocation platform 102 with the enterprise user device 103 (e.g., in preparation for transmitting and receiving program execution requests). In some instances, the enterprise user device 103 may identify whether a connection is already established with the quantum multi-objective resource allocation platform 102. If a connection is already established, the enterprise user device 103 might not re-establish the connection. If a connection is not yet established, the enterprise user device 103 may establish the first wireless data connection as described herein.

At step 203, the enterprise user device 103 may send a program execution request to the quantum multi-objective resource allocation platform 102. For example, the enterprise user device 103 may send a request to execute a program execution request in a distributed manner across multiple computing systems. In some instances, the enterprise user device 103 may send the program execution request while the first wireless data connection is established.

At step 204, the quantum multi-objective resource allocation platform 102 may receive the program execution request from the enterprise user device 103. For example, the quantum multi-objective resource allocation platform 102 may receive the program execution request via the communication interface 113 and while the first wireless data connection is established.

In some instances, the quantum multi-objective resource allocation platform 102 may initiate the program execution request without receiving a request from the enterprise user device 103. Rather, in these instances, the quantum multi-objective resource allocation platform 102 may automatically initiate the program execution request.

At step 205, the quantum multi-objective resource allocation platform 102 may identify program complexity of the program execution request. For example, the quantum multi-objective resource allocation platform 102 may identify a number of distributed computing systems (both dependent computing systems and controlling computing systems) needed to execute the request, available memory of these computing systems, cores of these computing systems, and/or other information. In some instances, the quantum multi-objective resource allocation platform 102 may represent this information as quantum bit (qubits).

Referring to FIG. 2B, at step 206, the quantum multi-objective resource allocation platform 102 may generate a plurality of candidate resource allocation solutions for processing the program execution request, along with corresponding scores indicating the processing efficiency of each identified solution. For example, the quantum multi-objective resource allocation platform 102 may input the quantum bits representing the program complexity (identified at step 205), information of the distributed resource platform 104, the program execution request itself, and/or other information into the quantum multi-objective optimization model, trained at step 201. Based on this input information, the quantum multi-objective optimization model may identify correlations between the complexity of the program execution request and/or a status of the distributed resource platform 104, and the complexities/resource statuses of historical requests used to train the quantum multi-objective optimization model.

In some instances, in performing its analysis, the quantum multi-objective optimization model may establish a quantum circuit based on the qubits representing complexity of the program execution request. In these instances, the quantum multi-objective optimization model may use quantum entanglement and/or quantum superposition to produce the candidate resource allocations. For example, the quantum superpositioning may be used to correctly order computing tasks of the program execution request (e.g., to ensure that the temporal sequence of events is correct). Additionally or alternatively, the quantum superpositioning may be used to identify all possible solutions. The quantum entanglement may be used to ensure that tasks dependent on each other remain connected (e.g., for execution at a common resource of the distributed resource platform 104). Additionally or alternatively, the quantum entanglement may be used to impose other constraints on the solutions. In some instances, use of the quantum superpositioning and/or entanglement may enable the quantum multi-objective optimization model to analyze multiple potential candidate resource allocations in parallel, which may e.g., conserve processing resources and reduce delays associated with such analysis.

At step 207, based on the stored correlations identified at step 206, the quantum multi-objective optimization model may identify a resource allocation score for each candidate resource allocation based on the resource allocation scores assigned in correlated historical scenarios. In these instances, a higher resource allocation score may indicate that a corresponding resource allocation may have higher processing efficiency, whereas a lower resource allocation score may indicate that a corresponding resource allocation may have a lower processing efficiency. In some instances, the quantum multi-objective optimization model may rank the candidate resource allocations based on the resource allocation scores (e.g., from lowest to highest). In some instances, the resource allocation score may be, for example, a value between 0 and 100.

In some instances, the quantum multi-objective optimization model may score the candidate resource allocations based on one or more objectives. For example, the quantum multi-objective optimization model may score the candidate resource allocations based on execution time using the following objective function: minimize

$$f ( execution ) = {\sum }_{i = 1}^{n} ExecutionTime ( {Task}_{i} ) * ResourceTime ( {Resource}_{i} ) .$$

For example, resource allocations with longer projected execution times may be scored lower than those with shorter projected execution times. In some instances, to score the quantum multi-objective optimization model may impose the following constraints on the candidate resource allocations. For example, the quantum multi-objective optimization model may ensure each task is assigned exactly one resource using the formula:

$${\sum }_{i = 1}^{n} ResourceAllocation ( {Task}_{i} {Resource}_{i} ) = 1.$$

Additionally or alternatively, the quantum multi-objective optimization model may ensure that dependent tasks are assigned to the same or nearby resources only after completion of their predecessor tasks using the formula: Resource Allocation(TaskᵢResourceᵢ)*CompletionTime(Taskⱼ)>=Resource Allocation(TaskⱼResourceⱼ)*CompletionTime(Taskᵢ). In these instances, If Taskᵢ is dependent on Taskⱼ then Taskᵢ is allocated to Resourceⱼ only after completion of Taskⱼ. Additionally or alternatively, the quantum multi-objective optimization model may allocate resources near memory resources holding relevant data. Additionally or alternatively, the multi-objective optimization model consider geographical proximity between tasks that require working on the same data.

Additionally or alternatively, the quantum multi-objective optimization model may score the candidate resource allocations based on communication overhead. For example, the resource allocation score may be higher the lower the communication overhead is e.g., by applying the following objective function: Minimize ƒ(communication)=Σ_{i,j}CommunicationOverhead(Taskᵢ,Taskⱼ)×ResourceAllocation(Taskᵢ, Resourceᵢ)×ResourceAllocation(Taskⱼ,Resourceⱼ). In these instances, a communication constraint may be applied, such as Σ_{i,j}CommunicationOverhead(Taskᵢ, Taskⱼ)≤MaxCommunication. Additionally or alternatively, a resource constraint may be applied, such as Σᵢ Resource Allocation(Taskᵢ, Resourceᵢ)=1.

Additionally or alternatively, the quantum multi-objective optimization model may score the candidate resource allocations based on throughput. For example, the resource allocation score may be higher as throughput increases using the following objective function: maximise ƒ(throughput)=Σᵢ Throughput(Resourceᵢ)×ResourceAllocation(Taskᵢ, Resourceᵢ). In these instances, a resource constraint may be applied, such as Σᵢ Resource Allocation(Taskᵢ, Resourceᵢ)=1.

Additionally or alternatively, the quantum multi-objective optimization model may score the candidate resource allocations based on how balanced the resource utilization is e.g., by applying the following objective function: Minimize ƒ(balance)=(Σᵢ ResourceUtilization(Resourceᵢ)−TargetUtilization)². In these instances, a resource constraint may be applied, such as Σᵢ Resource Allocation(Taskᵢ, Resourceᵢ)=1. Additionally or alternatively, the multi-objective optimization model may ensure that dependent tasks are assigned to the same/nearby resource only after completion of their predecessor tasks. Additionally or alternatively, the multi-objective optimization model may allocate resources near memory resources holding relevant data. Additionally or alternatively, the multi-objective optimization model may consider geographical proximity between tasks that require working on the same data.

In some instances, the quantum multi-objective optimization model may apply different weighting to different features of the model in scoring the resource allocations. For example the quantum multi-objective optimization model may weight the balance of resources higher than throughput in the scoring of the resource allocations, or the like.

At step 208, the quantum multi-objective resource allocation platform 102 may select a resource allocation from the candidate resource allocations. For example, the quantum multi-objective resource allocation platform 102 may select the highest ranked resource allocation.

At step 209, the quantum multi-objective resource allocation platform 102 may generate a resource execution script based on the selected resource allocation. For example, the quantum multi-objective resource allocation platform 102 may generate a script that, when executed by the quantum multi-objective resource allocation platform 102 and/or the distributed resource platform 104, causes processing of the program execution request at a plurality of distributed systems across the distributed resource platform 104.

Referring to FIG. 2C, at step 210, the quantum multi-objective resource allocation platform 102 may establish a connection with the distributed resource platform 104. For example, the quantum multi-objective resource allocation platform 102 may establish a second wireless data connection with the distributed resource platform 102 (e.g., in preparation for processing the program execution request). In some instances, the quantum multi-objective resource allocation platform 102 may identify whether a connection is already established with the distributed resource platform 104. If a connection is already established with the distributed resource platform 104, the quantum multi-objective resource allocation platform 102 might not re-establish the connection. If a connection is not yet established with the distributed resource platform 104, the quantum multi-objective resource allocation platform 102 may establish the second wireless data connection as described herein.

At step 211, the quantum multi-objective resource allocation platform 102 may communicate with the distributed resource platform 104 to execute the resource execution script. For example, the quantum multi-objective resource allocation platform 102 may communicate with the distributed resource platform 104 via the communication interface 113 and while the second wireless data connection is established.

At step 212, based on or in response to the execution of the resource execution script at step 211, the distributed resource platform 104 may execute the program execution request. For example, the distributed resource platform 104 may execute the program execution request across a plurality of distributed computing systems, which may, e.g., be part of the distributed resource platform 104. In some instances, this may include adding or removing computing resources to/from the distributed resource platform 104. Although the distributed resource platform 104 is illustrated as in a single figure element, this is for illustrative purposes only. The distributed resource platform 104 may be comprised of and/or otherwise represent any number of distributed computing resources without departing from the scope of the disclosure.

At step 213, the quantum multi-objective resource allocation platform 102 may establish a connection with the user device 105. For example, the quantum multi-objective resource allocation platform 102 may establish a third wireless data connection with the user device 105 to link the quantum multi-objective resource allocation platform 102 with the user device 105 (e.g., in preparation for sending information of the executed program request). In some instances, the quantum multi-objective resource allocation platform 102 may identify whether a connection is already established with the user device 105. If a connection is already established with the user device 105, the quantum multi-objective resource allocation platform 102, the quantum multi-objective resource allocation platform 102 might not re-establish the connection. Otherwise, if a connection is not yet established with the user device 105, the quantum multi-objective resource allocation platform 102 may establish the third wireless data connection as described herein.

Referring to FIG. 2D, at step 214, the quantum multi-objective resource allocation platform 102 may send program execution information (e.g., generated based on execution of the program execution request) to the user device 105. For example, the quantum multi-objective resource allocation platform 102 may send the program execution information to the user device 105 via the communication interface 113 and while the third wireless data connection is established. In some instances, the program execution information may be associated with user recommendations, and/or other information. In some instances, the quantum multi-objective resource allocation platform 102 may also send one or more commands directing the user device 105 to display the program execution information.

At step 215, the user device 105 may receive the program execution information sent at step 214. For example, the user device 105 may receive the program execution information while the third wireless data connection is established. In some instances, the user device 105 may also receive the one or more commands directing the user device 105 to display the program execution information.

At step 216, based on or in response to the commands directing the user device 105 to display the program execution information, the user device 105 may display the program execution information.

At step 217, the distributed resource platform 104 may provide feedback associated with processing the program execution request to the quantum multi-objective resource allocation platform 102. For example, the distributed resource platform 104 may provide processing information such as available memory, throughput, computer processing units, processing time, and/or other processing conditions. In some instances, the distributed resource platform 104 may provide the feedback while the second wireless data connection is established. In some instances, the quantum multi-objective resource allocation platform 102 may monitor the distributed resource platform 104 to collect this processing feedback.

At step 218, the quantum multi-objective resource allocation platform 102 may receive the feedback sent at step 217. For example, the quantum multi-objective resource allocation platform 102 may receive the feedback via the communication interface 113 and while the second wireless data connection is established.

At step 219, the quantum multi-objective resource allocation platform 102 may update the quantum multi-objective optimization model based on the feedback, which may, e.g., cause the quantum multi-objective optimization model to dynamically and continuously improve its ability to select optimal processing resource allocations for processing program execution requests in a distributed computing environment.

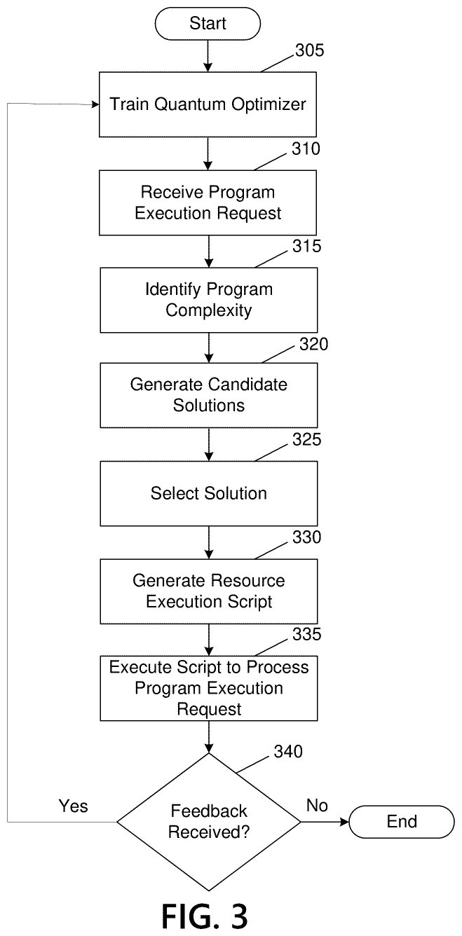

FIG. 3 depicts an illustrative method for using quantum computing for efficient optimization of resource allocation in accordance with one or more example embodiments. Referring to FIG. 3, at step 305, a computing platform comprising one or more processors, memory, and a communication interface may train a quantum optimization model. At step 310, the computing platform may receive a program execution request. At step 315, the computing platform may identify a complexity of the program execution request. At step 320, the computing platform may identify, based on the complexity and using the quantum optimization model, a plurality of candidate resource allocation solutions. At step 325, the computing platform may select a solution from the plurality of candidate resource allocation solutions. At step 330, the computing platform may generate a resource execution script based on the selected solution. At step 335, the computing platform may execute the resource execution script to process the program execution request using the selected resource allocation. At step 340, the computing platform may receive feedback on the processing. If feedback is received, the computing platform may return to step 305 to retrain the quantum optimization model. Otherwise, the method may end.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, cause the computing platform to:
receive a program execution request for execution across a distributed computing environment;
identify a complexity of the program execution request;
generate one or more qubit values representing the complexity;
input the one or more qubit values into a quantum multi objective optimization engine, wherein the quantum multi objective optimization engine is configured to output, using quantum superposition and quantum entanglement, and based on the one or more qubit values, a plurality of candidate solutions, and wherein each of the plurality of candidate solutions comprises a potential resource allocation for processing the program execution request;
score the plurality of candidate solutions based on one or more objectives;
select, based on the scoring, a first candidate solution;
generate, based on the first candidate solution, a resource allocation script; and
execute the resource allocation script, wherein executing the resource allocation script causes processing of the program execution request using a first resource allocation corresponding to the first candidate solution.

2. The computing platform of claim 1, wherein the memory stores additional computer readable instructions that, when executed by the at least one processor, cause the computing platform to:
train, based on historical program execution information, the quantum multi objective optimization engine, wherein the historical program execution information includes one or more of: computing resources, operation complexity, or program execution requests.

3. The computing platform of claim 1, wherein the memory stores additional computer readable instructions that, when executed by the at least one processor, cause the computing platform to:
monitor the first resource allocation to collect processing feedback; and
update, based on the processing feedback, the quantum multi objective optimization engine.

4. The computing platform of claim 1, wherein scoring the plurality of candidate solutions based on one or more objectives comprises applying different weighting to one or more features of the quantum multi objective optimization engine.

5. The computing platform of claim 1, wherein the plurality of candidate solutions are simultaneously analyzed based on the quantum superposition and the quantum entanglement.

6. The computing platform of claim 1, wherein the one or more qubit values represent one or more of: a number of computing devices in the distributed computing environment, a memory of the computing devices, or a number of cores per computing device.

7. The computing platform of claim 1, wherein scoring the plurality of candidate solutions comprises scoring, based on one or more constraints, the plurality of candidate solutions, wherein each of the one or more constraints are defined by a corresponding objective function.

8. The computing platform of claim 7, wherein a constraint of the one or more constraints comprises minimizing execution time, and wherein the corresponding objective function comprises:
$$minimize f ( execution ) = {\sum }_{i = 1}^{n} 〚 ExecutionTime ( {Task}_{i} ) * ResourceTime ( {Resource}_{i} 〛 ) .$$

9. The computing platform of claim 7, wherein a constraint of the one or more constraints comprises reducing communication overhead, and wherein the corresponding objective function comprises:
$$minimize f ( communication ) = {\sum }_{i , j} 〚 CommunicationOverhead ( {Task}_{i} , {Task}_{j} 〛 ) \times ResourceAllocation ( {Task}_{i} , {Resource}_{i} ) \times ResourceAllocation ( {Task}_{j} , {Resource}_{j} ) .$$

10. The computing platform of claim 7, wherein a constraint of the one or more constraints comprises maximizing throughput, and wherein the corresponding objective function comprises:
$$maximise f ( throughput ) = {\sum }_{i} 〚 Throughput ( {Resource}_{i} 〛 ) \times ResourceAllocation ( {Task}_{i} , {Resource}_{i} ) .$$

11. The computing platform of claim 7, wherein a constraint of the one or more constraints comprises balancing resource utilization, and wherein the corresponding objective function comprises:
$${minimize f ( balance ) = ( {\sum }_{i} 〚 ResourceUtilization ( {Resource}_{i} 〛 ) - TargetUtilization )}^{2} .$$

12. A method comprising:
at a computing platform comprising at least one processor, a communication interface, and memory:
receiving a program execution request for execution across a distributed computing environment;
identifying a complexity of the program execution request;
generating one or more qubit values representing the complexity;
inputting the one or more qubit values into a quantum multi objective optimization engine, wherein the quantum multi objective optimization engine is configured to output, using quantum superposition and quantum entanglement, and based on the one or more qubit values, a plurality of candidate solutions, and wherein each of the plurality of candidate solutions comprises a potential resource allocation for processing the program execution request;
scoring the plurality of candidate solutions based on one or more objectives;
selecting, based on the scoring, a first candidate solution;
generating, based on the first candidate solution, a resource allocation script; and
executing the resource allocation script, wherein executing the resource allocation script causes processing of the program execution request using a first resource allocation corresponding to the first candidate solution.

13. The method of claim 12, further comprising:
training, based on historical program execution information, the quantum multi objective optimization engine, wherein the historical program execution information includes one or more of: computing resources, operation complexity, or program execution requests.

14. The method of claim 12, further comprising:
monitoring the first resource allocation to collect processing feedback; and
updating, based on the processing feedback, the quantum multi objective optimization engine.

15. The method of claim 12, wherein scoring the plurality of candidate solutions based on one or more objectives comprises applying different weighting to one or more features of the quantum multi objective optimization engine.

16. The method of claim 12, wherein the plurality of candidate solutions are simultaneously analyzed based on the quantum superposition and the quantum entanglement.

17. The method of claim 12, wherein the one or more qubit values represent one or more of: a number of computing devices in the distributed computing environment, a memory of the computing devices, or a number of cores per computing device.

18. The method of claim 12, wherein scoring the plurality of candidate solutions comprises scoring, based on one or more constraints, the plurality of candidate solutions, wherein each of the one or more constraints are defined by a corresponding objective function.

19. The method of claim 18, wherein a constraint of the one or more constraints comprises minimizing execution time, and wherein the corresponding objective function comprises:
$$minimize f ( execution ) = {\sum }_{i = 1}^{n} 〚 ExecutionTime ( {Task}_{i} ) * ResourceTime ( {Resource}_{i} 〛 ) .$$

20. One or more non-transitory computer-readable media storing instructions that, when executed by a computing platform comprising at least one processor, a communication interface, and memory, cause the computing platform to:
receive a program execution request for execution across a distributed computing environment;
identify a complexity of the program execution request;
generate one or more qubit values representing the complexity;
input the one or more qubit values into a quantum multi objective optimization engine, wherein the quantum multi objective optimization engine is configured to output, using quantum superposition and quantum entanglement, and based on the one or more qubit values, a plurality of candidate solutions, and wherein each of the plurality of candidate solutions comprises a potential resource allocation for processing the program execution request;
score the plurality of candidate solutions based on one or more objectives;
select, based on the scoring, a first candidate solution;
generate, based on the first candidate solution, a resource allocation script; and
execute the resource allocation script, wherein executing the resource allocation script causes processing of the program execution request using a first resource allocation corresponding to the first candidate solution.
